(19) United States
(12) Patent Application Publication
(10) Pub. No.: US 2025/0032352 A1
(43) Pub. Date: Jan. 30, 2025

(54) VIBRATORY STIMULATION APPARATUS AND VIBRATORY STIMULATION METHOD

(71) Applicants: TOYOTA BOSHOKU KABUSHIKI KAISHA, Aichi (JP); NATIONAL UNIVERSITY CORPORATION KANAZAWA UNIVERSITY, Ishikawa (JP)

(72) Inventors: Hidetaka NAGAYASU, Toyota-shi (JP); Kenji KAWANO, Owariasahi-shi (JP); Kyoko MORI, Nagoya-shi (JP); Yuichi NISHIKAWA, Kanazawa-shi (JP); Toshihiko KOMATSUZAKI, Kanazawa-shi (JP)

(73) Assignees: TOYOTA BOSHOKU KABUSHIKI KAISHA, Aichi (JP); NATIONAL UNIVERSITY CORPORATION KANAZAWA UNIVERSITY, Ishikawa (JP)

(21) Appl. No.: 18/775,490

(22) Filed: Jul. 17, 2024

(30) Foreign Application Priority Data
Jul. 27, 2023 (JP) 2023-122480

(51) Int. Cl. A61H 23/00; A61H 23/02

(52) U.S. Cl. CPC A61H 23/006; A61H 23/02; A61H 2201/1207; A61H 2201/1647; A61H 2201/165; A61H 2203/0425; A61H 2203/0456

(57) ABSTRACT

A vibratory stimulation apparatus and a vibratory stimulation method are provided. The vibratory stimulation apparatus includes at least one vibration generator configured to apply a vibration to an agonist muscle of a body of a user to thereby apply a stimulation to an antagonist muscle that forms a pair with the agonist muscle. The vibratory stimulation method includes applying a vibration to an agonist muscle of the body of a user to thereby apply the stimulation to an antagonist muscle that forms a pair with the agonist muscle.

### CROSS-REFERENCE TO RELATED APPLICATIONS

This application claims the benefit of Japanese Patent Application No. 2023-122480 filed on Jul. 27, 2023 with the Japan Patent Office, the entire disclosure of which is incorporated herein by reference.

### BACKGROUND

The present disclosure relates to a vibratory stimulation apparatus and a vibratory stimulation method. Japanese Unexamined Patent Application Publication No. 2011-143061 and International Patent Application Publication No. 2016/125312 disclose devices that prevent reduction of muscle strength by electrical stimulations. These devices are designed to perform stimulations of a minimal strength required for maintaining muscle strength under a condition that is less likely to cause muscle fatigue.

### SUMMARY

The aforementioned devices require complicated settings to obtain extensive effects while inhibiting negative components such as discomfort.

In one aspect of the present disclosure, it is desirable to provide a vibratory stimulation apparatus that can recover or maintain muscle strength with a simple setting. One mode of the present disclosure is a vibratory stimulation apparatus comprising at least one vibration generator configured to apply a vibration to an agonist muscle of the body of a user to thereby apply a stimulation to an antagonist muscle that forms a pair with the agonist muscle. In other words, the at least one vibration generator may be the vibratory stimulation apparatus configured to apply a vibration to at least a given agonist muscle of the body of the user.

Such a configuration allows a stimulation to be applied to a motor nerve in the antagonist muscle by applying a vibration (even a small vibration) to the agonist muscle through a mechanism of an antagonistic muscle reflex. That is, the inventors of the present disclosure have found that an application of a small vibration to the agonist muscle allows a stimulation to be applied to the motor nerve in a large region of the antagonist muscle that forms a pair with the agonist muscle.

This allows a stimulation to be applied to the motor nerve in a portion of the body of the user where a direct vibratory stimulation causes discomfort. As a result, muscle strength of the body of the user can be recovered and/or maintained with a simple setting. Also, muscle strength of the body of the user can be recovered and/or maintained without giving discomfort to the user.

In one mode of the present disclosure, the vibration generated by the at least one vibration generator may have an amplitude that is equal to or larger than 0.001 mm and equal to or smaller than 1 mm. Such a configuration allows recovery or maintenance of muscle strength of the body of the user while reducing discomfort of the user caused by an application of a large vibration.

One mode of the present disclosure may further comprise a seat on which the user can be seated, and a supporter that covers the lower limb of the user from above. The at least one vibration generator may be disposed at a portion of the supporter that covers the agonist muscle. Such a configuration allows reduction of the vibratory stimulation to the buttocks, where a lot of nerve groups exists, as well as an application of a stimulation from a midthigh, a tendon portion adjacent to a knee, and the like to the antagonist muscle in the vicinity of the buttocks.

One mode of the present disclosure may comprise a cast that is wearable on the upper limb or the lower limb of the user. In other words, the vibratory stimulation apparatus may comprise the cast instead of the supporter. The at least one vibration generator may be disposed at a portion of the cast that covers the agonist muscle. Such a configuration allows an application of a stimulation with a small vibration to the antagonist muscle in the upper limb or the lower limb where movement is limited by the cast. This can accelerate progression of recovery of muscle strength after removal of the cast.

In one mode of the present disclosure, the at least one vibration generator may include a first vibration generator disposed at a portion of the vibratory stimulation apparatus that covers the agonist muscle, and a second vibration generator disposed at a portion of the vibratory stimulation apparatus that covers the antagonist muscle. According to such a configuration, a stimulation is applied to each of two antagonistic muscles forming a pair, and thus an effect of recovering muscle strength is more facilitated.

One mode of the present disclosure may comprise a mat that can support the user from below, and a supporter that covers the agonist muscle of the user from above. The at least one vibration generator may be disposed at a portion of the supporter that covers the agonist muscle. Such a configuration allows an application of a stimulation to the antagonist muscle in a part of the body of the user that faces the mat without disposing the vibration generator in the mat. This can recover muscle strength of the body of the user lying on the mat without impairing comfort of the mat.

Another aspect of the present disclosure is a vibratory stimulation method comprising applying a vibration to an agonist muscle of the body of a user to thereby apply a stimulation to an antagonist muscle that forms a pair with the agonist muscle.

Such a configuration allows an application of a stimulation to a motor nerve in the antagonist muscle by applying a small vibration to the agonist muscle through a mechanism of an antagonistic muscle reflex. As a result, muscle strength of the body of the user can be recovered or maintained with a simple setting.

### BRIEF DESCRIPTION OF THE DRAWINGS

Example embodiments of the present disclosure will be described hereinafter with reference to the accompanying drawings, in which:

FIG. 1 is a schematic side view of a vibratory stimulation apparatus according to an embodiment;

FIG. 2 is a schematic diagram illustrating a n antagonistic muscle reflex;

FIG. 3 is a schematic side view of a vibratory stimulation apparatus according to an embodiment different from the embodiment of FIG. 1; and

FIG. 4 is a schematic side view of a vibratory stimulation apparatus according to an embodiment different from the embodiment of FIG. 1.

### DETAILED DESCRIPTION OF EXEMPLARY EMBODIMENTS

### 1. First Embodiment

### [1-1. Configurations]

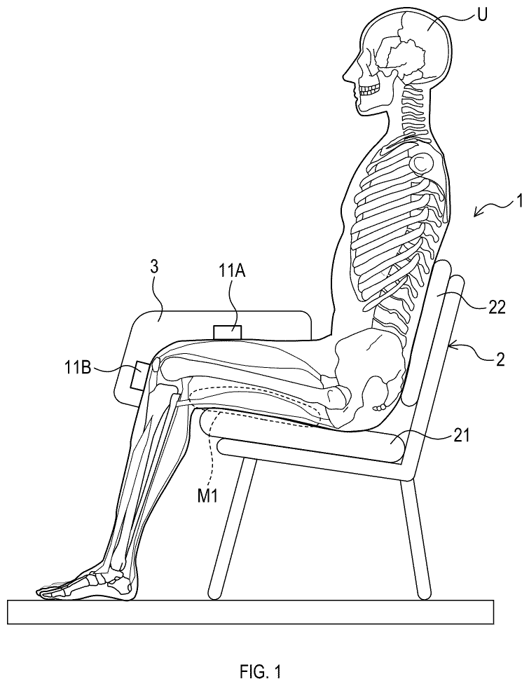

A vibratory stimulation apparatus 1 shown in FIG. 1 is used for maintaining or recovering muscle strength and athletic performance of the lower limb of a user U. The vibratory stimulation apparatus 1 comprises a seat 2, a supporter 3, a first vibration generator 11A, and a second vibration generator 11B.

The vibratory stimulation apparatus 1 is configured to apply a vibratory stimulation to the lower limb of the user U through each of the vibration generators 11A and 11B while the user U is seated on the seat 2. This allows inhibition of aging-related reduction in muscle strength and muscle mass, and prevention of frailty (that is, vulnerability).

Thus, the muscle strength of the lower limb of the user U can be maintained or recovered without the user U performing an exercise by himself or herself. As a result, balance in the lower limb and walking function of the user U are expected to be maintained or improved.

### <Seat>

The seat 2 includes a seat portion 21 that supports the buttocks of the user U, and a backrest 22. In FIG. 1, the backrest 22 of the seat 2 supports the user U in such a manner that the back of the user U stands upright. Alternatively, the backrest 22 may be reclinable.

### <Supporter >

The supporter 3 is a wearable equipment that covers the lower limb of the user U from above. The supporter 3 is, for example, fixed to clothes of the user U or the seat 2 while covering the lower limb of the user U. The supporter 3 is disposed with the seat 2 in such a manner that the lower limb of the user U is held between the supporter 3 and the seat 2 in up-down directions and/or front-back directions. The supporter 3 may be divided into a plurality of parts.

### <Vibration Generator>

The first vibration generator 11A and the second vibration generator 11B are configured to apply a vibration to an occupant of the seat 2 (that is, the user U). Specifically, the first vibration generator 11A and the second vibration generator 11B are configured to apply a vibration to an agonist muscle of the body of the user U. When a vibration is applied to the agonist muscle of the body of the user U, a stimulation is applied also to an antagonist muscle that forms a pair with the agonist muscle to which the vibration has been applied. In other words, the first vibration generator 11A and the second vibration generator 11B are configured to apply a vibration to the agonist muscle of the body of the user U to thereby apply a stimulation to the antagonist muscle that forms a pair with the agonist muscle to which the vibration has been applied. Furthermore, the first vibration generator 11A and the second vibration generator 11B apply a vibration to a common agonist muscle. Specifically, in the common agonist muscle, the first vibration generator 11A applies a vibration to a muscle belly, and the second vibration generator 11B applies a vibration to a tendon.

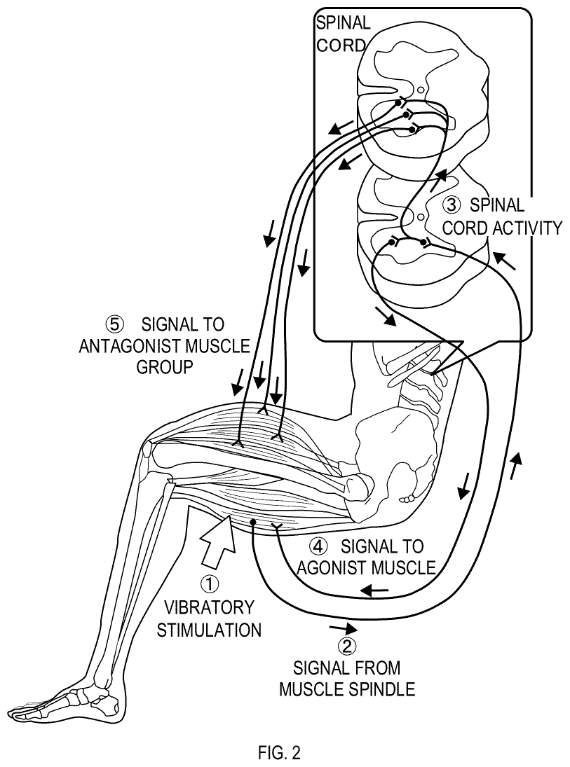

FIG. 2 illustrates a mechanism in which a vibratory stimulation generates a signal in a human body. When a vibratory stimulation is applied to a given agonist muscle (hereinafter, referred to as “vibration applied muscle”), a signal from a muscle spindle of the vibration applied muscle is transferred to a spinal cord through neurons. In the spinal cord, the signal causes a spinal cord activity, and then a signal is transferred to an antagonist muscle group that corresponds to the vibration applied muscle. Accordingly, an antagonistic muscle reflex is obtained, in which a pseudo vibratory stimulation is applied to the antagonist muscle to which the vibration is not directly applied.

As the first vibration generator 11A and the second vibration generator 11B, widely known actuator type vibration bodies can be used. It is desirable that the vibration generated by each of the vibration bodies (that is, the vibration generated by each of the vibration generators 11A and 11B) has a frequency equal to or higher than 20 Hz and equal to or lower than 110 Hz. It is also desirable that the vibration generated by each of the vibration bodies has an amplitude equal to or larger than 0.001 mm and equal to or smaller than 1 mm.

Such frequency and amplitude enables a muscle spindle of the antagonist muscle to effectively respond to the vibratory stimulation (in other words, an excitation of the muscle spindle is accelerated). As a result, a recovery effect or a maintenance effect on muscle strength is enhanced. Thus, such frequency and amplitude allows recovery or maintenance of muscle strength of the body of the user U while reducing discomfort of the user U caused by an application of a large vibration (that gives an unpleasant sensation or uncomfortable feeling to the user). In a case where the frequency of the vibration is lower than 20 Hz or exceeds 110 Hz, the muscle spindle of the antagonist muscle does not effectively respond to the vibratory stimulation (in other words, the excitation of the muscle spindle of the antagonist muscle does not occur). The same applies to a case where the amplitude of the vibration is smaller than 0.001 mm or exceeds 1 mm.

As shown in FIG. 1, each of the first vibration generator 11A and the second vibration generator 11B is disposed at a portion of the supporter 3 that covers the agonist muscle to which a vibration is input.

The first vibration generator 11A is configured to apply a vibration to a region including a muscle belly portion of an anterior thigh muscle (for example, quadriceps femoris muscle). Specifically, the first vibration generator 11A is disposed at a portion of the supporter 3 that faces a thigh.

The second vibration generator 11B is configured to apply a vibration to a region including a tendon portion of the anterior thigh muscle (for example, quadriceps femoris muscle). Specifically, the second vibration generator 11B is disposed at a portion of the supporter 3 that faces a patella.

The vibratory stimulation applied to the muscle belly portion by the first vibration generator 11A and the vibratory stimulation applied to the tendon portion by the second vibration generator 11B each provide a stimulatory effect to the corresponding antagonist muscle of the muscle belly portion and the tendon portion (for example, biceps femoris muscle). That is, it is possible to apply a stimulation to a muscle of a target region M1 that is close to the buttocks of the user U and is relatively large by applying a vibration to a part of the body of the user U that is away from the buttocks of the user U. Moreover, it is possible to choose a part to be stimulated from different parts (for example, the muscle belly portion and the tendon portion) with respect to a single antagonist muscle.

It should be noted that both of the first vibration generator 11A and the second vibration generator 11B may be arranged at each of the left and right legs of the user U, or both of the first vibration generator 11A and the second vibration generator 11B may be arranged at either one of the left and right legs of the user U.

### <Vibratory Stimulation Method>

A vibratory stimulation method according to the present embodiment comprises applying a vibration to an agonist muscle of the body of the user U through the vibratory stimulation apparatus 1 to thereby apply a stimulation to an antagonist muscle that forms a pair with the agonist muscle.

### [1-2. Effects]

According to the embodiment explained above in detail, the following effects can be obtained.

(1a) It is possible to stimulate a motor nerve in the antagonist muscle by applying a small vibration to the agonist muscle through a mechanism of an antagonistic muscle reflex. This allows an application of a stimulation to a motor nerve in a part of the body of the user U where a stimulation with a large vibration or a stimulation with a direct vibration causes discomfort. As a result, muscle strength can be recovered and/or maintained with a simple setting. Also, muscle strength can be recovered and/or maintained without giving discomfort to the user U.

(1b) It is possible to reduce the vibratory stimulation to the buttocks, where a lot of nerve groups exists, as well as to apply a stimulation from a midthigh, a tendon portion adjacent to a knee, and the like to the antagonist muscle in the vicinity of the buttocks.

### 2. Second Embodiment

### [2-1. Configurations]

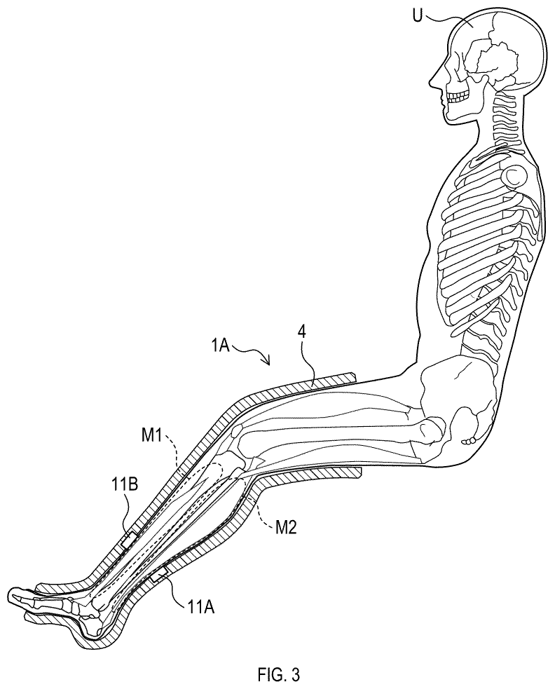

A vibratory stimulation apparatus 1A illustrated in FIG. 3 is used for maintaining or recovering muscle strength and athletic performance of the lower limb and/or the upper limb of the user U. The vibratory stimulation apparatus 1A comprises a cast 4, the first vibration generator 11A, and the second vibration generator 11B.

The vibratory stimulation apparatus 1A is configured to apply a vibratory stimulation to the user U wearing the cast 4 through the vibration generators 11A and 11B. This allows inhibition of reduction in muscle strength and muscle mass associated with a limitation of movement due to a fracture, and the like.

### <Cast>

The cast 4 is a wearable equipment that can be worn on the lower limb of the user U. The cast 4 is, for example, worn by the user U by being wrapped around either one of the legs of the user U. The cast 4 completely covers the leg of the user U in circumferential directions.

### <Vibration Generators>

The first vibration generator 11A and the second vibration generator 11B are the same as those in the first embodiment and are each configured to apply a vibration to a wearer of the cast 4 (that is, the user U).

Each of the first vibration generator 11A and the second vibration generator 11B is disposed at a portion of the cast 4 that covers an agonist muscle to which the vibration is input.

The first vibration generator 11A is configured to apply a vibration to a region including the back side of a example, lower leg (for gastrocnemius muscle). Specifically, the first vibration generator 11A is disposed at a portion of the cast 4 that faces a calf.

The second vibration generator 11B is configured to apply a vibration to a region including the front side of the lower leg (for example, anterior tibial muscle). Specifically, the second vibration generator 11B is disposed at a portion of the cast 4 that faces a shin.

The vibratory stimulation applied to a muscle of the back side of the lower leg by the first vibration generator 11A provides a stimulatory effect to a target region M1 including the corresponding antagonist muscle (for example, anterior tibial muscle). The vibratory stimulation applied to a muscle of the front side of the lower leg by the second vibration generator 11B provides a stimulatory effect to a target region M2 including the corresponding antagonist muscle (for example, gastrocnemius muscle).

That is, the second vibration generator 11B is disposed at a portion that covers the antagonist muscle corresponding to the agonist muscle to which the first vibration generator 11A inputs the vibration. Either one of the first vibration generator 11A or the second vibration generator 11B may continuously generate a vibration; or, the first vibration generator 11A and the second vibration generator 11B may alternately generate a vibration.

Each of the first vibration generator 11A and the second vibration generator 11B may be arranged at a part of the body other than the lower leg (for example, a thigh, a knee, and the like) so as to cover a different one of two antagonistic muscles forming a pair. The cast 4 may be worn on the upper limb. Each of the first vibration generator 11A and the second vibration generator 11B may be arranged at an upper arm, a forearm, an elbow, and the like to cover a different one of two antagonistic muscles forming a pair.

### [2-2. Effects]

According to the embodiment explained above in detail, the following effects can be obtained.

(2a) It is possible to apply a stimulation with a small vibration to the antagonist muscle in the upper limb and/or the lower limb where movement is limited by the cast 4. This can accelerate progression of recovery of muscle strength after removal of the cast 4.

(2b) It is possible to facilitate a recovery effect on muscle strength since the first vibration generator 11A and the second vibration generator 11B each apply stimulations to corresponding one of the two antagonistic muscles forming a pair.

### 3. Third Embodiment

### [3-1. Configurations]

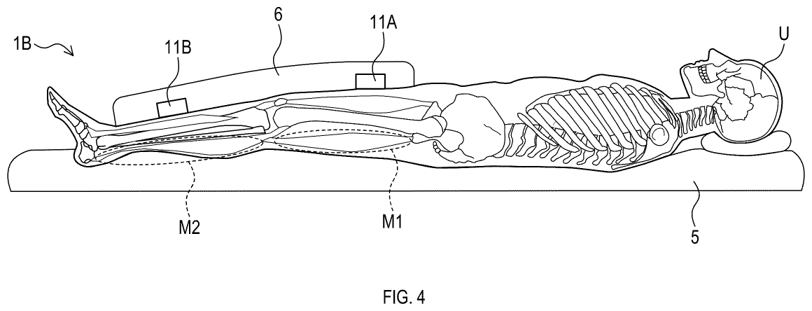

A vibratory stimulation apparatus 1B illustrated in FIG. 4 is used for maintaining or recovering muscle strength and athletic performance of the lower limb of the user U. The vibratory stimulation apparatus 1B comprises a mat 5, a supporter 6, the first vibration generator 11A, and the second vibration generator 11B.

The vibratory stimulation apparatus 1B is configured to apply a vibratory stimulation to the user U through the vibration generators 11A and 11B while the user U is lying on the mat 5. This allows inhibition of aging-related reduction in muscle strength and muscle mass and prevention of frailty.

### <Mat >

The mat 5 is a member that can support the user U lying on the mat 5 from below. The mat 5 has flexibility.

### <Supporter>

The supporter 6 is a wearable equipment that covers the lower limb of the user U from above. The supporter 6 is, for example, fixed to clothes of the user U or the mat 5 while covering the lower limb of the user U. The supporter 6 is disposed with the mat 5 in such a manner that the lower limb of the user U is held between the supporter 6 and the mat 5 in the up-down directions and/or the front-back directions. The supporter 6 may be divided into a plurality of parts.

### <Vibration Generator>

The first vibration generator 11A and the second vibration generator 11B are the same as those in the first embodiment and are configured to apply a vibration to the user U lying on the mat 5.

Each of the first vibration generator 11A and the second vibration generator 11B is disposed at a portion of the supporter 6 that covers an agonist muscle to which a vibration is input. Each of the first vibration generator 11A and the second vibration generator 11B applies a vibration to one of the agonist muscles different from each other.

The first vibration generator 11A is configured to apply a vibration to a region including a muscle of the front side of the midthigh, (for example, quadriceps femoris muscle). Specifically, the first vibration generator 11A is disposed at a portion of the supporter 6 that faces the thigh.

The second vibration generator 11B is configured to apply a vibration to a region including a muscle of the front side of a lower leg (for example, anterior tibial muscle). Specifically, the second vibration generator 11B is disposed at a portion of the supporter 6 that faces a shin.

The vibratory stimulation applied to the muscle of the front side of the midthigh by the first vibration generator 11A provides a stimulatory effect to a target region M1 including the corresponding antagonist muscle (for example, biceps femoris muscle). The vibratory stimulation applied to the muscle of the front side of the lower leg by the second vibration generator 11B provides the stimulatory effect to a target region M2 including the corresponding antagonist muscle (for example, gastrocnemius muscle).

Accordingly, each of the first vibration generator 11A and the second vibration generator 11B can provide a stimulatory effect to a relatively large part of the body of the user U that is supported by the mat 5. This allows reduction of discomfort of the user U caused by vibrating the mat 5 itself.

Each of the first vibration generator 11A and the second vibration generator 11B may be disposed at a different one of left and right legs of the user U or may be disposed at either one of the left and right legs of the user U. It is possible to provide a stimulatory effect to different parts of the body at the same time by the first vibration generator 11A and the second vibration generator 11B vibrating at the same time.

### [3-2. Effects]

According to the embodiment explained above in detail, the following effects can be obtained.

(3a) It is possible to apply a stimulation to the antagonist muscle in a part of the body of the user U that faces the mat 5 without the vibration generator being disposed in the mat 5. This allows recovery of muscle strength of the body of the user U lying on the mat 5 without impairing comfort of the mat 5.

### [4. Other Embodiments]

Although the embodiments of the present disclosure have been described so far, the present disclosure is not limited to the aforementioned embodiments and can be implemented in various forms.

(4a) In the vibratory stimulation apparatuses according to the aforementioned embodiments, the number of the vibration generator is not limited to two. That is, the vibratory stimulation apparatus may comprise a single vibration generator or may comprise three or more vibration generators.

(4b) Functions of one element in the aforementioned embodiments may be achieved by two or more elements. Functions of two or more elements may be integrated into one element. A part of the configurations in the aforementioned embodiments may be omitted. At least a part of the configurations in the aforementioned embodiments may be added to or replaced with other part of the configurations in the aforementioned embodiments. Any and all modes included in the technical ideas that are identified by the languages recited in the claims are embodiments of the present disclosure.

What is claimed is:

1. A vibratory stimulation apparatus comprising:
a seat including a seat portion that supports buttocks of a user, and a backrest that supports a back of the user;
a supporter being a wearable equipment that covers a lower limb of the user; and
a vibration generator integrated in the supporter and configured to apply a vibration to an agonist muscle of a body of the user,
the vibration generator including a first vibration generator that applies a vibration to a muscle belly of the agonist muscle, and a second vibration generator that applies a vibration to a tendon of the agonist muscle.

2. A vibratory stimulation apparatus comprising:
at least one vibration generator configured to apply a vibration to an agonist muscle of a body of a user to thereby apply a stimulation to an antagonist muscle that forms a pair with the agonist muscle.

3. The vibratory stimulation apparatus according to claim 2,
wherein a vibration generated by the at least one vibration generator has an amplitude that is equal to or larger than 0.001 mm and equal to or smaller than 1 mm.

4. The vibratory stimulation apparatus according to claim 2, further comprising:
a seat on which the user is seated, and
a supporter that covers a lower limb of the user from above,
wherein the at least one vibration generator is disposed at a portion of the supporter that covers the agonist muscle.

5. The vibratory stimulation apparatus according to claim 2, further comprising:
a cast that is wearable on an upper limb or a lower limb of the user,
wherein the at least one vibration generator is disposed at a portion of the cast that covers the agonist muscle.

6. The vibratory stimulation apparatus according to claim 5,
wherein the at least one vibration generator includes a first vibration generator disposed at a portion of the cast that covers the agonist muscle, and a second vibration generator disposed at a portion of the cast that covers the antagonist muscle.

7. The vibratory stimulation apparatus according to claim 2, further comprising:
a mat that supports the user from below, and
a supporter that covers the agonist muscle of the user from above,
wherein the at least one vibration generator is disposed at a portion of the supporter that covers the agonist muscle.

8. A vibratory stimulation method comprising:
applying a vibration to an agonist muscle of a body of a user to thereby apply a stimulation to an antagonist muscle that forms a pair with the agonist muscle.
